(19) United States
(12) Patent Application Publication
(10) Pub. No.: US 2017/0178547 A1
(43) Pub. Date: Jun. 22, 2017

(54) Applications of Ultra High Solids emulsions

(71) Applicant: Kenneth Lin, San Marino, CA (US)

(72) Inventor: Kenneth Lin, San Marino, CA (US)

(21) Appl. No.: 14/975,748

(22) Filed: Dec. 19, 2015

(51) Int. Cl. G09F 3/10; B05D 3/00

(52) U.S. Cl. CPC G09F 3/10; B05D 3/007; G09F 2003/0242

(57) ABSTRACT

Processing and use of ultra-high solids formulations wherein no drying step is needed for the formulation to be incorporated in a wide variety of applications. Adhesives, top-coatings, sealants, fasteners are amongst the use areas.

### CROSS REFERENCE TO RELATED APPLICATIONS

This application claims the benefit of the U.S. Provisional Application 62/095,486 filed Dec. 22, 2014.

### FIELD OF INVENTION

This invention relates to various uses of ultra-high solids emulsions. Particularly the present invention relates to the use of ultra high solids emulsions in label applications where the reduction in water content of the adhesive leads to improved ways of application of an emulsion adhesive in label making. In particular these methods lead to large savings in material and processing in PSA labeling machines and leads to an ability to successfully coat sensitive substrates.

### DESCRIPTION OF RELATED ART

### Current Industry Practice—

A typical adhesive construction is a three layer sandwich. See FIG. 1B. Between a facestock (sometimes called label material) and a release liner (a throw-away component) is a layer of adhesive. Before application, the liner is first peeled away from this sandwich exposing the adhesive that remains on the facestock. The label is then applied to a desired substrate such that the adhesive helps anchor the facestock to a target substrate. The application of the facestock to the substrate is carefully done so that the end result is a lamination that does not show any wrinkles. The facestock is also sometimes referred to as label material.

Labeling adhesives can be water-based, solvent-based or hot melts. Performance and cost determine their selection. Water based adhesives are often in the form of emulsions and a significant portion of them are pressure sensitive emulsion adhesives.

Water-based emulsion adhesives typically have a lot of water in them. These adhesives need to be dried after they are coated. This necessitates the use of dryers in a coating line. Pressure sensitive emulsion adhesives display their full pressure sensitive adhesive properties after the water based emulsions are dried and the water is removed. Typically water needs to be removed during the manufacturing of a pressure sensitive emulsion adhesive construction.

A pressure sensitive adhesive (PSA) labeling machine uses a label roll shown in FIG. 1A. The label roll is made as a three layer sandwich as shown in FIG. 1B. The label making process that utilizes adhesive coaters and dryers. The facestock in the three layer sandwich is usually pre die-cut to desired label size and shape. In a typical labeling machine, the label facestock is unwound from its roll form and peeled-off from the liner with a peeler bar and then blown, tamped, rolled or wiped onto to a target substrate such as a bottle or a box as shown in FIG. 2.

Pre-prepared label rolls are used in a typical labeling machine. The use of such pre-prepared rolls in a labeling machine is convenient from an operational viewpoint. The label roll making and the labeling operations are thereby decoupled and can run efficiently independently. The label roll making operations have different timescales. For example, drying processes used in label making are in the order of minutes while laminating or peeling processes in a labeling operation are in the order of seconds. The time scales of coating and drying in a roll making operation are different than time scales of peeling and laminating operations in a labeling application. Typically, the slowest step is the drying step and generally it is operationally inefficient to combine it with the fast steps of laminating. As a result the label roll making and the label application machinery is typically run independently and separately.

The two processes are sometimes combined when there is no drying involved because now the time scales of label making and label application are of the same order. This is seen when one uses hot-melt adhesives for labeling. The hot melt adhesive is coated without any solvent carrier and hence there is no drying needed at all. Without a drying step, one can coat the hot-melt adhesive and apply the coated label in tandem. However, it is routinely acknowledged in the industry that hot melt adhesives are messy to operate, need to be heated to high temperature for coating because of their very high viscosities, give off vapors that can be irritating, introduce black specks in coating if adhesive lines are not clean and are overheated, makes equipment cleanup difficult and have a limited range in their adhesive performance. As a result, one does not see such label applicators on a wide scale.

One also sees consumer glues (casein) being directly applied on facestock prior to placement on a substrate. They contain large amounts of water that really needs to be dried. This results in wrinkled labels, thicker adhesive coats, short open tack times, potential of bacterial contamination leading to foul smells and overall poor label appearance when compared to typical PSA labels.

However, for the large class of emulsion PSAs, which also have significant amount of water in them, it is necessary to have a separate drying step to remove the large quantity of water. As a result, the roll making and the label application steps are decoupled as discussed earlier. The label roll making with emulsion adhesives is usually done ahead of time with coaters and dryers and the coated rolls made therefrom are subsequently used in label application machines. When done ahead of time, a release liner is required in the wound-up coated rolls. The release liner is expensive, usually more expensive than the label itself. Also, the throw-away release liner is a waste of precious natural resource.

### Basic Methods of Coating Adhesives in Making Label Constructions—

Two methods of making such emulsion adhesive constructions rolls are well-known in the industry—by direct or indirect coating. See FIG. 3.

A direct coating deposits the wet adhesive directly onto a facestock and is then dried and subsequently laminated with a release liner. Very few paper label facestocks can successfully survive the high level of water deposited on them without causing significant wrinkling.

There are many disadvantages of a direct coating, especially with the typical emulsion adhesives with their high water content; the wrinkling of the coated substrates due to moisture absorption by the substrate from the wet adhesive, the non-uniform spread ability of the adhesive due to surface tension effects, the non-uniform drying of the adhesive leading to patchy adhesive coatings, exposure of facestock to high temperature drying conditions that can affect its moisture balance and its wrinkling, amongst others.

On the other hand, an indirect coating coats a release liner substrate first, then the adhesive is dried and subsequently laminated it to the label facestock. The label facestock does not see any water as it is laminated to the dried adhesive at the end. This allows one to use water sensitive label facestock but it requires that the adhesive be tacky for a smooth transfer operation.

Typically, in an indirect coating process (sometimes called transfer coating), a low viscosity emulsion of about 200 to 2000 cps with about 45%-50% water content is first coated on a release coated liner at a coating station and then dried usually with heated air in a pass-through dryer. Once the adhesive is dry, a facestock is laminated to the adhesive side. The ovens in general are large and expensive to construct, occupy a large footprint and a very large amount of energy is consumed in operating the drying oven.

Here too there are difficulties. A flowable (usually low viscosity) adhesive generally regresses when coated on the low surface energy surface of the liner. Quick heating and drying of the adhesive is necessary to lock in a uniform coating on the liner. By becoming dry the viscosity of the adhesive builds up and reduces the chances of regression and flow that causes non-uniformity in coating. One can coat with a high viscosity adhesive, but that is not conducive to a high speed coating operation. So, on one hand you want the coating viscosity to be low so that you can coat fast, while on the other hand you want it to be high so that it will not regress and cause non-uniformity in the coating.

Above coating methods necessitate the use of a liner which is typically thrown away when the label facestock is applied onto a box or bottle substrate in a labeling machine. This liner material is typically wasted. Any process that eliminates the liner waste is economically attractive. This can only be done if the label making process is done in tandem with the label application process.

### Reduction of Water Content in Adhesive a Worthwhile Goal

In the case of emulsion adhesives, combining the process of label-making and label application into one usable process presents severe challenges. This stems from the large quantity of water that needs to be evaporated in a drying process. If this water can be eliminated with the use of ultra-high solids emulsions to the extent that a drying step is no longer needed, the two steps of label making and label application can be combined. This would result in a cheaper efficient process for a PSA labeling machine.

K. Lin in U.S. Pat. No. 8,729,157 teaches methods to make ultra-high solids (UHS) emulsion adhesives. Lin teaches extremely high solids adhesives—above 60% solids. These UHS adhesives form a separate class distinct from convention emulsion PSA and are differentiated by their lower water content, yet are flowable and coatable. Such adhesives can be used to coat label facestock directly.

The use of ultra high solids emulsions is attractive as it reduced the impact of water on the label facestock because of the greatly reduced water content. In using UHS emulsion adhesives the amount of water is reduced by more than 30% when compared with emulsion adhesives used in the industry today. The lower amount of water results in lower impact on the label facestock when directly coated onto the label facestock in terms of mechanical strength retention and wrinkling. The smaller amount of water dissipates faster and no drying may be needed. Rogue natural drying from an applied label will be adequate to dry the reduced water load for full functional performance.

### BRIEF SUMMARY OF THE INVENTION

Ultra-high solids emulsion formulations can be used in adhesives, top coats, glue, sealant applications. The elimination of the drying step in the application of the formulation is key advantage of great commercial benefit. As a result any process which utilizes such high solids emulsion formulations benefits from this elimination in terms of effort, cost and simplicity and can be regarded as an inventive process to make the same products made by processes that need the drying step. In the detailed description below are highlighted some limited embodiments. We do not mean to narrow the application set for ultra-high solids adhesives by specifying only a part range of potential applications.

### BRIEF DESCRIPTION OF DRAWINGS

FIG. 1A A typical web roll of adhesive construction fed to a labeling machine.

FIG. 1B Cross section of web roll

FIG. 2 Conventional label application process in a labeling machine

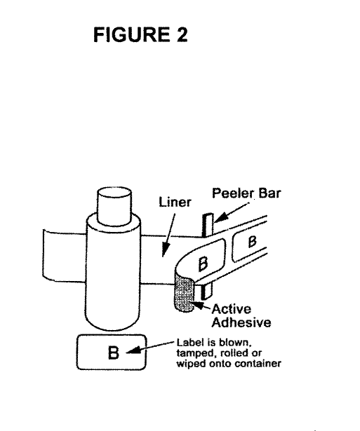

FIG. 3 Direct and Transfer Coating of adhesive to make a label construction

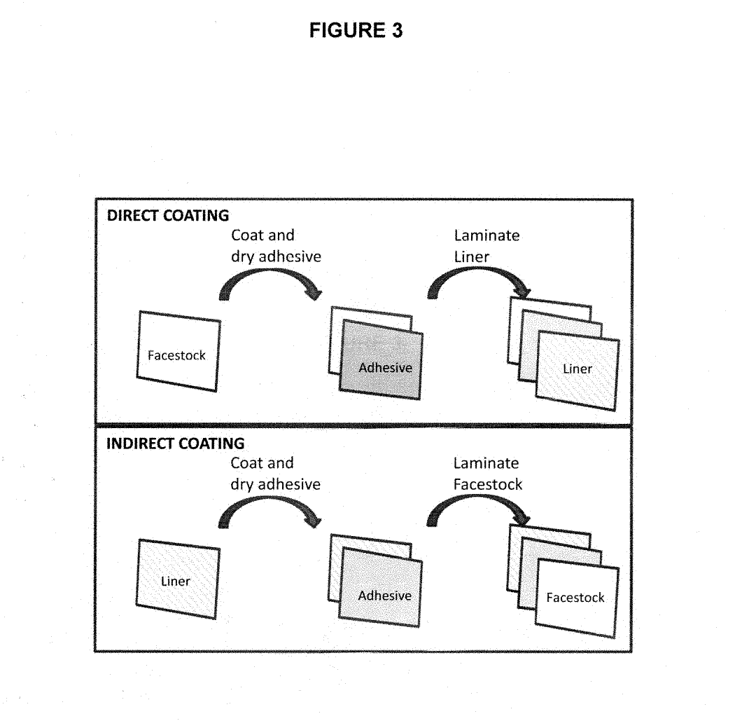

FIG. 4A Web Format Embodiment

FIG. 4B Discreet Label Format Embodiment

FIG. 4C Coat directly on packages Format Embodiment

### DETAILED DESCRIPTION OF INVENTION

Inventive Combination of Label Making and Label Application Process with UHS Emulsions.

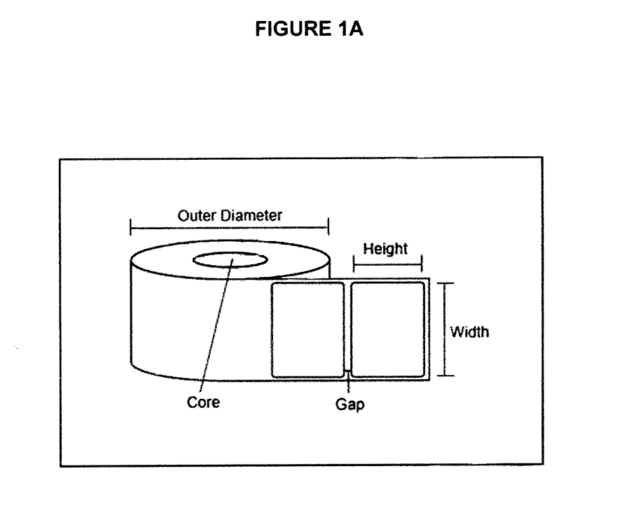

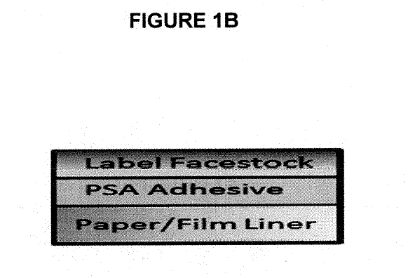

A label facestock can be directly coated with the ultra-high solids adhesive and laminated to the box or bottle substrate in one pass. There is no longer a need for pre-prepared label construction rolls shown in FIG. 1A. This inventive process greatly simplifies both the label making and application process. It allows the labeler to adhesive-coat the labels on his machine as needed cost-effectively.

The drastic reduction of the water load by using ultra-high solids adhesives and the resulting lack of a drying step can be of significant economic benefit in labeling operations. It also presents an opportunity to combine the steps of direct coating and label application into one continuous operation. It is interesting to note that we do not see such a combination in the industry today with conventional emulsion adhesives due to their high water content.

The combination of label roll construction (in web form or discreet stackable form) and label application into one single operation results in a process that requires no dryers, reduces overall equipment footprint, provides operational simplicity by reducing inventories of rolls, reduces liner waste and maintains high label quality.

An ultrahigh solids emulsion eliminates the need for a special drying step altogether. An ultra-high solids adhesive has significantly less water—low enough to be capable of drying without ovens. Rogue natural drying will occur and will be adequate to functionally dry the adhesive upon application to the box or the bottle substrate. Ultra-high solids emulsions have a water content of less than 35%. This reduced level of water when compared with conventional emulsions leads to many operating advantages—no drying step, elimination of the need for release liners since the adhesive is coated at the labeler, no wrinkling of facestock from excessive water due to reduced water content.

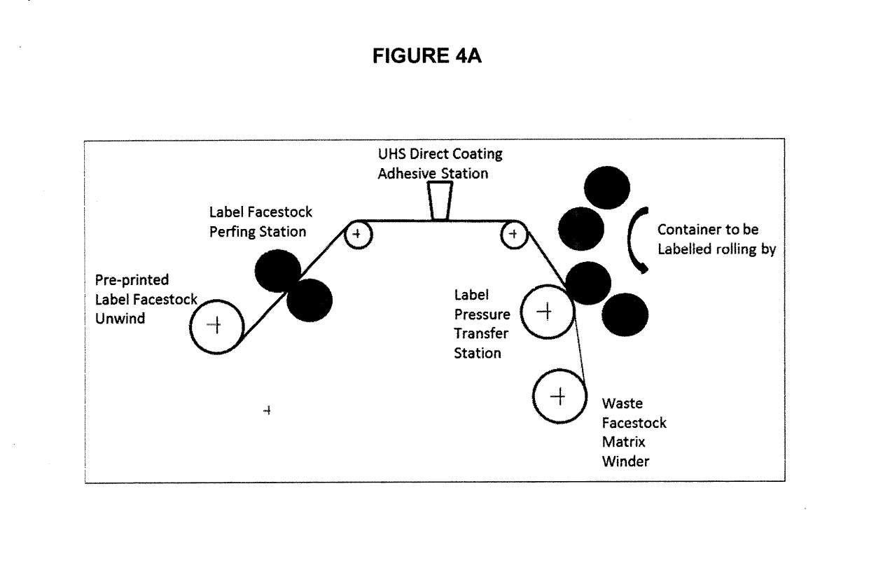

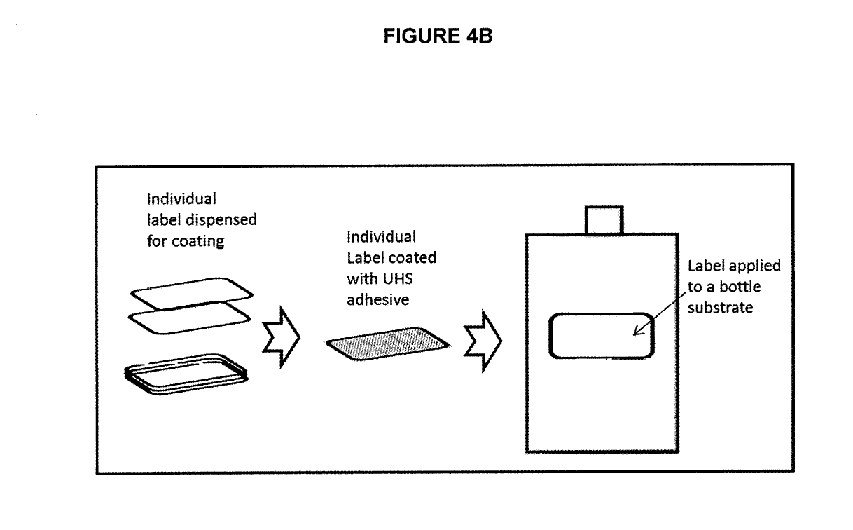

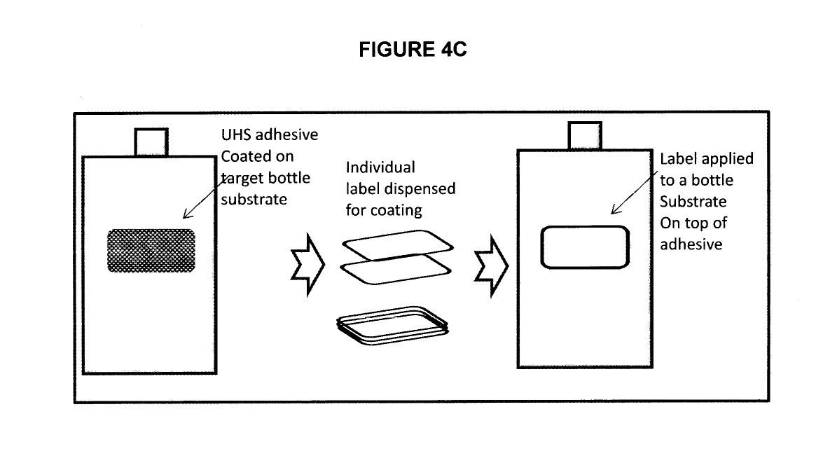

In one embodiment, in a continuous web format, as shown in FIG. 4A, the label facestock is per (oration cut to the label size desired, then direct pattern coated with the UHS adhesive on one side such that the adhesive coated area matches the perfed label facestock areas. The coated label area is then separated from the remainder facestock matrix after application onto the box or bottle substrate. The UHS adhesive dries quickly without any drying oven and has instant tack prior to lamination onto the box or bottle substrate.

In yet another embodiment, the UHS adhesive coating the a label facestock may be accomplished by a transfer process wherein the adhesive is coated onto another surface at first which then subsequently is made to release the coated adhesive layer to a label facestock surface in a two step adhesive coating process.

In another embodiment, a single label is dispensed from a stack of facestock labels, as shown in FIG. 4B, is then transported to a UHS adhesive coating station where the facestock is coated on one side with the UHS adhesive. The coated label is then applied to the box or bottle substrate. Once again no drying step.

In yet another embodiment, the mechanism to dispense a stacked label onto bottles can be similar to a laser printer. Labels are dispensed one by one by a roller and sensor mechanism, the label facestock is then coated with an adhesive and subsequently rolled onto a bottle substrate. The target bottle can simply act like one of the rollers at the exit of the coating stage.

In yet another embodiment as shown in FIG. 4C, a UHS adhesive is coated directly on the final box or bottle substrate. Precut label facestock is dispensed and laminated on top of the coated adhesive layer to complete the labeling application. This provides a lot of simplicity in the label application process. Alternatively, the UHS adhesive coating on the target bottle or box substrate may be accomplished by a transfer process wherein the adhesive is coated onto another surface at first which then is subsequently made to release the coated adhesive layer to a box or bottle substrate in a two step adhesive coating process.

In yet another embodiment, a UHS adhesive can be applied directly onto paper and allowed to thy. The coated adhesive can be laminated to the box or bottle substrate in a wrinkle free manner to result in a high quality lamination.

The adhesive can be applied by various direct coating methods including but not limited to knife coating, roll coating, wire coating, extrusion coating, slot coating, gap coating, rod coating, gravure coating, reverse gravure coating, air knife coating. Any coating process capable of metered delivering the UHS adhesive to the facestock substrate is envisioned. The coatings can be pattern coated if desired.

The UHS adhesive can also be applied directly onto the label facestock in a wiping action. The term coating above also encompasses such a wiping action.

The adhesive may also be printed onto the label facestock such as jet printers, nozzle printers, gravure printers and other machines capable of printing patterns of UHS adhesive onto a web.

The label stock can be directly coated in web roll form or precut stack form. The web roll form allows continuous processing as the labels are transported by a moving web between the coating and the laminating stations while the stack form allows easy dispensing and discrete label processing of each individual label. In principle the whole process can also be accomplished manually by first coating an individual label with a UHS adhesive and then applying the label to a box or bottle substrate.

The adhesive can be deposited onto continuous label stock web or it can be applied to cut-out individual labels. Alternatively, the adhesive can be applied directly to a target substrate and then a matching facestock (label) can be laminated over the adhesive over a matching target area. In principle, all of these processes can be automated or manual.

The adhesive can be supplied to the coating head from a cartridge under pressure, or it can be fed into a nip of rollers and subsequently metered onto a substrate.

The process of elimination of liners in such a coating process results in a liner-less mode of operation thereby resulting is cost savings.

The choice of “box or bottle substrate” language is intended to make the descriptions clearer. It is not intended to limit the range of application substrates in any manner.

The UHS emulsions can also be effectively used in sealant applications making the package sealing processes very cost-effective and efficient. This would include all sealing applications where the UHS emulsion would serve as a sealant. All the methods described herein can be applied to such substrates used in sealing applications.

The UHS emulsions can also be used for in place sealant duty such as in sealant caulkings. The reduced water drying load of UHS emulsions enables such applications.

The UHS emulsions could also be formulated into fast drying paint. They would present less pollution to the environment as less volatiles would be present.

Formulations can be made to be tacky or non-tacky. Each can lead to a separate set of applications in various areas.

UHS adhesives can also be used in simple glueing applications as in arts and crafts projects. Similarly other fastening applications can also be considered.

Substrates coated can be temperature sensitive, heat sensitive or water sensitive. For example a PVC film can be heat sensitive, paper can be water sensitive (forms wrinkles with excess water), a topo coated film for thermal printers can be temperature sensitive. The use of high solids formulation in processing eliminates the need to subject the coated substrate to thigh temperature or water. As a result many new cost saving processing options open up in converting such sensitive materials.

11

We claim:

1. A method to a coat a substrate comprising applying a ultra-high solids adhesive formulation on the substrate without the use of any subsequent drying equipment to dry the applied formulation.

2. A process according to claim 1 wherein the substrate is water sensitive, temperature sensitive or heat sensitive substrate.

3. A process according to claim 1 where the f results in either a tacky or non-tacky surface.

4. The process of claim 1 in direct or transfer coating a formulation to a substrate.

5. The process of claim 1 in the making of an adhesive construction.

6. The process of claim 1 in the making of an adhesive label construction.

7. The process of claim 1 in sealant applications.

8. (canceled)

9. (canceled)

10. (canceled)

11. Any product made by the process of claim 1.

12. The product of claim 11 wherein the coated product is an adhesive construction.

13. The product of claim 11 wherein the high solids formulation is used as a sealant.

14. The coating method of claim 1 where the coated label is further individually dispensed and applied onto the surface of an object to be labeled.

15. The method of claim 14 wherein the substrate is either a preprinted roll of labels or a stack of sheets of labels.

16. The method of claim 14 where the adhesive is directly or indirectly coated onto the substrate.

17. The method of claim 14 where the ultra-high solids adhesive is patterned.

18. A continuous labeling process comprising
(a) coating a label substrate roll with ultra-high solids adhesive,
(b) individually dispensing the coated label,
(c) applying the individual coated label onto the surface of an object to be labeled.

19. The process of claim 18 where the adhesive is directly or indirectly coated.

20. The process of claim 18 where the label substrate is a sheet or a continuous web.

21. The process of claim 18 where the label substrate is either pre-printed or in-line printed before the coating step (a).

22. The process of claim 18 where ₜhe label substrate is perfed or is inline perfed before the coating step (a).

23. The process of claim 18 where the ultra-high solids adhesive is patterned.
